(19) United States
(12) Patent Application Publication
(10) Pub. No.: US 2016/0224063 A1
(43) Pub. Date: Aug. 4, 2016

(54) SYSTEM AND METHOD FOR SUPPORTING A MAIN HOUSING OF A MOBILE COMPUTING DEVICE IN A SUPPORTED OPERATIVE ORIENTATION

(71) Applicant: Lenovo (Singapore) Pte. Ltd., New Tech Park (SG)

(72) Inventors: Jason Grimme, Cary, NC (US); Russell Speight VanBlon, Raleigh, NC (US); Spencer Michael Guy, Raleigh, NC (US)

(21) Appl. No.: 14/613,481

(22) Filed: Feb. 4, 2015

(51) Int. Cl. G06F 1/16; F16M 11/06; F16M 11/12; F16M 11/04

(52) U.S. Cl. CPC G06F 1/1624; F16M 11/041; F16M 11/06; F16M 11/12

(57) ABSTRACT

A system may include a main housing including at least one control unit and a display screen, and an input interface support stand including an input interface integrally connected to a stabilizer. The input support stand is movably secured to the main housing and movable between a retracted position in which the input interface support stand is securely retracted in relation to the main housing, and a supporting position in which the input interface support stand supports the main housing in a supported operative orientation.

### BACKGROUND

Embodiments of the present disclosure generally relate to mobile computing devices, and, more particularly, to systems and methods for supporting mobile computing devices in operative orientations.

Mobile computing devices, such as laptop computers, electronic tablets, smart phones, and various other handheld devices, are ubiquitous. A slate-style mobile computing device includes an input interface, such as a keyboard, that slides out from a main housing. For example, a known cellular smart phone includes a main housing that includes a display and a number pad and keyboard that slides out from the main housing in a direction that is parallel to a plane in which the display resides. In contrast, a flip-type cellular phone includes a pivotal interface at which an input interface pivots between open and closed position, similar to a book.

A known type of mobile computing device includes a stand that unfolds from a back of a main housing. In an unfolded position, the stand allows the mobile computing device to stand upright, so that a user may view a display and interact therewith, such as through an interactive touch screen.

Another known type of mobile computing devices includes a keyboard that unfolds from a front of a main housing. In an unfolded position, the keyboard supports the main housing in an upright orientation.

As can be appreciated, however, a computing device that is supported through a support stand extending from a rear surface, or with a keyboard extending from a front surface, may be susceptible to tipping over. For example, when a stand extends from a rear surface of a main housing, a force exerted into a top rear surface of the main housing may cause the computing device to tip over, such that a display screen may impact a surface of a structure on which it is positioned. In this manner, the computing device may be damaged.

Accordingly, a need exists for a system and method of safely and easily supporting a mobile computing device in an operative orientation.

### SUMMARY

Certain embodiments of the present disclosure provide a system that may include a main housing having one or more processors and a display screen. An input interface support stand may include an input interface integrally connected to a stabilizer. The input support stand is movably secured to the main housing and movable between a retracted position in which the input interface support stand is securely retracted in relation to the main housing, and a supporting position in which the input interface support stand supports the main housing in a supported operative orientation.

In at least one embodiment, the input interface is positioned to a first side of a plane in which the display screen resides in the supporting position, and the stabilizer is positioned to a second side of the plane in the supporting position. The first side is opposite from the second side, such as a front side and a back side.

The input interface and the stabilizer may have a common central plane. For example, a common central plane may pass through both the input interface and the stabilizer.

In at least one embodiment, the input interface support stand is movable between the retracted position and an extended position in which the input interface outwardly extends from the main housing. A base of the input interface support is parallel to a plane in which the display screen resides in the extended position. The input interface support stand may be pivoted between the extended position and the supporting position.

The stabilizer includes may include a flat panel. Alternatively, the stabilizer may include one or more beams, braces, or the like. The input interface may include one or both of a keyboard and a touchscreen, for example. In at least one embodiment, the input interface is removably connected to the stabilizer.

The user interface support stand may include a pivot member, and the main housing may include one or more guide tracks having one or more pivot terminals. One or more portions of the pivot member are retained within the one or more guide tracks.

Certain embodiments of the present disclosure provide a method that may include movably securing an input interface support stand to a main housing of a mobile computing device. The input interface support stand may include an input interface integrally connected to a stabilizer. The main housing may include one or more processors and a display screen. The method may also include moving the input interface support stand between a retracted position, in which the input interface support stand is securely retracted in relation to the main housing, and a supporting position, in which the input interface support stand supports the main housing in a supported operative orientation.

### BRIEF DESCRIPTION OF THE DRAWINGS

FIG. 1 illustrates a perspective front view of a mobile computing device, according to an embodiment of the present disclosure.

FIG. 2 illustrates a perspective front view of an input interface support stand slid out from a main housing of a mobile computing device, according to an embodiment of the present disclosure.

FIG. 3 illustrates a perspective lateral view of opposed lateral brackets of a main housing of a mobile computing device, according to an embodiment of the present disclosure.

FIG. 4 illustrates a top view of an input interface support stand, according to an embodiment of the present disclosure.

FIG. 5 illustrates a perspective front view of a mobile computing device supported in an upright orientation by an input interface support stand, according to an embodiment of the present disclosure.

FIG. 6 illustrates a lateral view of a mobile computing device having an input interface support stand in a retracted position, according to an embodiment of the present disclosure.

FIG. 7 illustrates a lateral view of an input interface support stand in a sliding position in relation to a main housing of a mobile computing device, according to an embodiment of the present disclosure.

FIG. 8 illustrates a lateral view of an input interface support stand in a fully-extended slid position in relation to a main housing of a mobile computing device, according to an embodiment of the present disclosure.

FIG. 9 illustrates a lateral view of an input interface support stand in a pivoting position in relation to a main housing of a mobile computing device, according to an embodiment of the present disclosure.

FIG. 10 illustrates a lateral view of an input interface support stand supporting a main housing of a mobile computing device in an upright orientation, according to an embodiment of the present disclosure.

FIG. 11 illustrates a flow chart of a method of supporting a mobile computing device in an upright orientation on a surface, according to an embodiment of the present disclosure.

FIG. 12 illustrates a perspective front view of a mobile computing device supported in an upright orientation by an input interface support stand, according to an embodiment of the present disclosure.

FIG. 13 illustrates a perspective front view of a mobile computing device supported in an upright orientation by an input interface support stand, according to an embodiment of the present disclosure.

FIG. 14 illustrates a simplified block diagram of a mobile computing device, according to an embodiment of the present disclosure.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

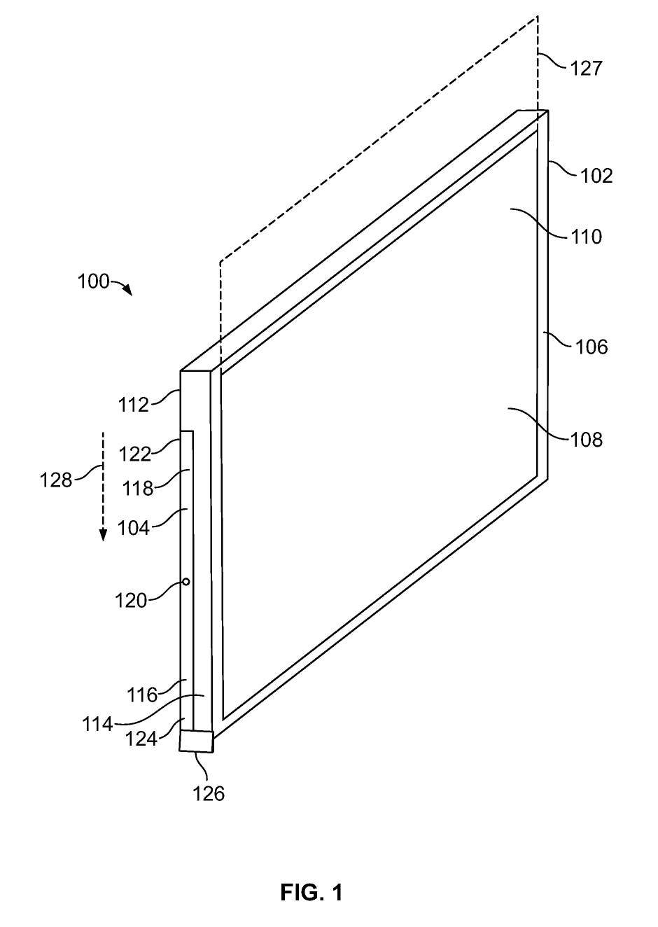

FIG. 1 illustrates a perspective front view of a mobile computing device 100, according to an embodiment of the present disclosure. The mobile computing device 100 is mobile or portable in that it may be readily moved from place to place by an individual, such as by being placed within a purse, bag, pocket, worn on a belt, or the like. For example, the mobile computing device may be a laptop computer, an electronic tablet, a cellular and/or smart phone, a personal digital assistant, or other such handheld devices.

The mobile computing device 100 may include a main housing 102 and an input interface support stand 104 that is movably secured to the main housing 102. The interface support stand 104 may be moved between a retracted position, in which the interface support stand 104 is securely retained within a recessed or other such area of the main housing 102, an extended position, in which the interface support stand 104 outwardly extends in relation to the main housing 102 (for example, the input interface support stand 104 outwardly sliding in a direction that is parallel to a display screen 108 of the main housing 102), and a supporting position, in which the input interface support stand 104 supports the main housing 102 in an operative orientation, such as an upright orientation.

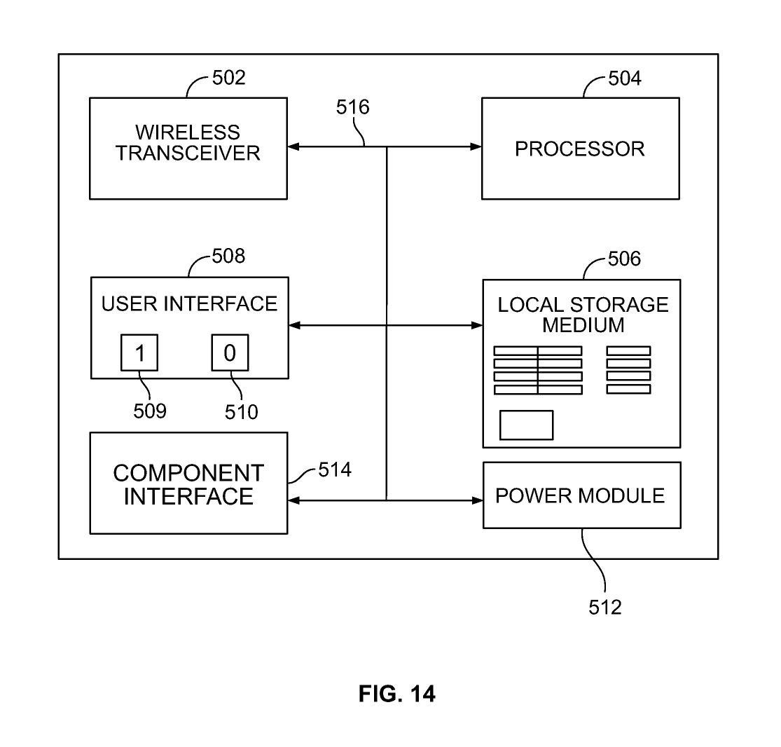

The main housing 102 may include an outer frame 106 that securely contains and support a display screen 108, such as a monitor that is configured to display various types of data, such as video, text, and the like. The main housing 102 also securely contains various computing and/or processing devices (not shown in FIG. 1), such as described with respect to FIG. 14.

As shown, the display screen 108 is positioned on a front surface 110 of the main housing 102. In a retracted position, the input interface support stand 104 is securely connected within a retaining area, such as a recessed area, formed within or on a rear surface 112 of the main housing 102 by opposed lateral brackets 114.

The input interface support stand 104 includes an input interface 116 integrally connected to a stabilizer 118, such as a flat panel, board, brace(s), beam(s), or the like. A pivot member 120, such as a pin, post, stud, cylinder, tube, or the like, outwardly extends from lateral surfaces of the input interface support stand 104 between the input interface 116 and the stabilizer 118. For example, the pivot member 120 may outwardly extend from a middle portion of the input interface support stand 104.

In the retracted position as shown in FIG. 1, the input interface support stand 104 may be securely connected to the main housing 102, such as through a snapable, latchable, or other such engagement. For example, an end 122 of the input interface support stand 104 may be snapably or latchably secured to a reciprocal feature of the main housing 102. Further, an opposite end 124 of the input interface support stand 104 may securely abut into a barrier wall 126, which may include or otherwise define internal pivot terminals, as described below.

While not shown in FIG. 1, the lateral brackets 114 may include guide tracks in which the pivot member 120 is secured. For the sake of clarity, portions of the lateral brackets 114 that include the guide tracks are not shown in FIG. 1. The pivot terminals may be positioned at terminal ends of the guide tracks.

In operation, in order to support the mobile computing device in an upright orientation and expose the input interface 116, the input interface support stand 104 is engaged by a user and urged in a direction that is parallel to a plane 127 in which the display screen resides in the direction of arrow 128. For example, as shown in FIG. 1, the input interface stand 104 is slid down from the main housing 102 in the direction of arrow 128. As noted above, the input interface support stand 104 is secured to the main housing 102 in the retracted position. The securing connection(s) between the input interface support stand 104 and the main housing 102 may be configured to release with a desired amount of exerted force in the direction of arrow 128. For example, the securing connections may be configured to withstand a certain amount of force, but to release when that force is exceeded.

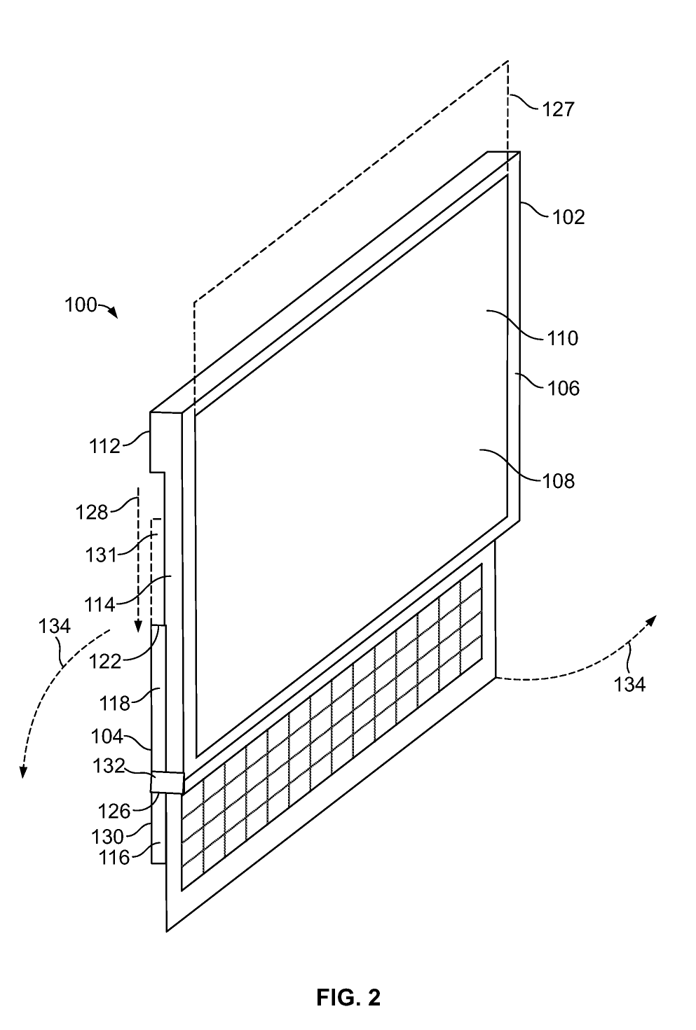

FIG. 2 illustrates a perspective front view of the input interface support stand 104 slid out from the main housing 102 of the mobile computing device 100, according to an embodiment of the present disclosure. As shown, the input interface support stand 104 has been slid down in the direction of arrow 128 to a position in which the pivot member(s) 120 (hidden from view in FIG. 2) is pivotally retained within pivot terminals within the lateral brackets 114. In the position shown in FIG. 2, a base 130 of the input interface support stand 104 resides in a plane 131 that is parallel to the plane 127 in which the display screen 108 resides. Further, the input interface 116 is exposed and extends below the main housing 102, while the stabilizer 118 is behind at least a portion of the rear surface 112 of the main housing 102. In order to securely support the mobile computing device 100 on a surface, such as that of a table, the input interface support stand 104 is pivoted about a pivot axis 132 defined by a longitudinal axis of the pivot member 120 within the pivot terminals in a direction noted by arc 134.

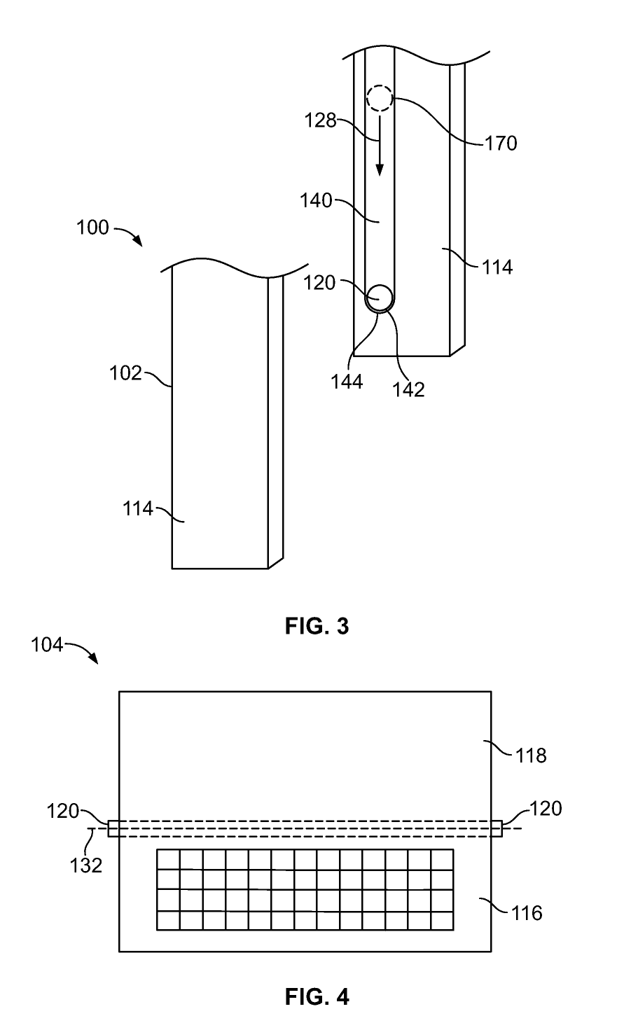

FIG. 3 illustrates a perspective lateral view of the opposed lateral brackets 114 of the main housing 102 of the mobile computing device 100, according to an embodiment of the present disclosure. For the sake of clarity, the display screen 108 is not shown in FIG. 3. Each bracket 114 may include a guide track 140 (the opposed guide tracks 140 being aligned with one another) that includes a pivot terminal 142 at a bottom terminal end. Each guide track 140 may be a recessed channel formed within interior surfaces of a lateral bracket 114 that is sized and shaped to slidably retain a pivot member 120 of the input interface support stand 104 (shown in FIGS. 1 and 2). For example, each pivot member 120 may be or include a cylindrical post that fits within a guide track 140. The pivot terminal 142 may be defined by an arcuate wall 144 that conforms to the shape of the pivot member 120. Accordingly, the pivot terminal 142 provides a barrier past which the pivot member 120 is unable to pass in the direction of arrow 128. However, because the pivot member 120 is configured to cradled by the pivot terminal 142, the pivot member 120 is able to pivot or otherwise rotate within the pivot terminal 142 about the pivot axis 132.

Alternatively, the lateral brackets 114 may not include guide tracks that extend to pivot terminals, as shown. Instead, the lateral brackets 114 may include retaining channels at one end and the pivot terminals at an opposite end. In this manner, the input interface support stand may simply be removed from the retaining channels and slid down towards the pivot terminals without the use of connecting guide tracks.

FIG. 4 illustrates a top view of the input interface support stand 104, according to an embodiment of the present disclosure. As shown, the pivot member 120 may be or include a single cylindrical rod that extends through the input interface support stand 104. The pivot member 120 includes a central longitudinal axis that provides the pivot axis 132. Optionally, instead of a single cylindrical rod that extends through the input interface support stand 104, the pivot member 120 may include two aligned cylindrical pivot studs extending from opposite sides.

Referring to FIGS. 3 and 4, opposite ends of the pivot member 120 are configured to be slid down the guide tracks 140 in the direction of arrow 128 until they are retained by the pivot terminals 142. After the ends of the pivot member 120 are within respective pivot terminals 142, the input interface support stand 104 may be pivoted to a supporting position. The pivot terminals 142 may securely retain the ends of the pivot member 120, such as through an interference fit, so that the input interface support stand 104 may be positioned and secured at a desired orientation in relation to the main housing 102. Alternatively, the latches, clasps, hooks, or the like may be used to secure the input interface support stand 104 in a desired orientation in relation to the main housing 102.

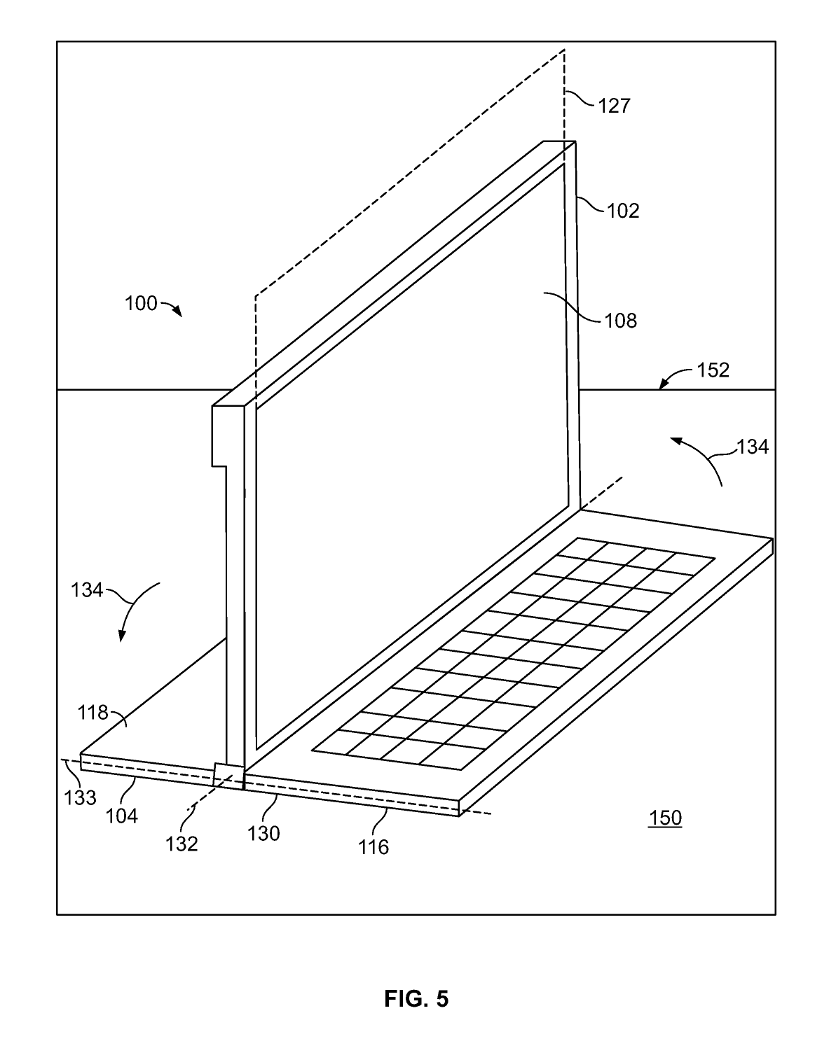

FIG. 5 illustrates a perspective front view of the mobile computing device 100 supported in an upright orientation by the input interface support stand 104, according to an embodiment of the present disclosure. As shown in FIG. 5, the input interface support stand 104 has been slid down from the main housing 102 such that the ends of the pivot member 120 (hidden from view in FIG. 5) are pivotally retained within the pivot terminals 142 (hidden from view in FIG. 5). The input interface support stand 104 has been pivoted about the pivot axis 132 in the directions of arcs 134, such that the input interface 116 is positioned in front of the plane 127 in which the display screen 108 resides, while the stabilizer 118 is positioned behind the plane 127 in which the display screen 108. The base 130 of the input interface support stand 104 provides a flat surface that abuts an upper surface 150 of a structure 152, such as a table. In this manner, the input interface support stand 104 supports the mobile computing device 100 in an upright orientation both in front of and behind the main housing 102, thereby providing a stable support that protects the mobile computing device from tipping over.

The stabilizer 118 and the input interface 116 of the input interface support stand 104 have a common central plane 133. The base 130 of the input interface support stand 104 may be a flat surface that is parallel with the common central plane 133. The pivot axis 132 extends through at least a portion of the common central plane 133.

As shown, the input interface 116 may be or include a keyboard. Optionally, the input interface 116 may be or include various other interfaces that allow a user to interact with the mobile computing device 100. For example, the input interface 116 may be or include an electronic touchscreen, an electronic stylus pad, a roller controller, and/or the like.

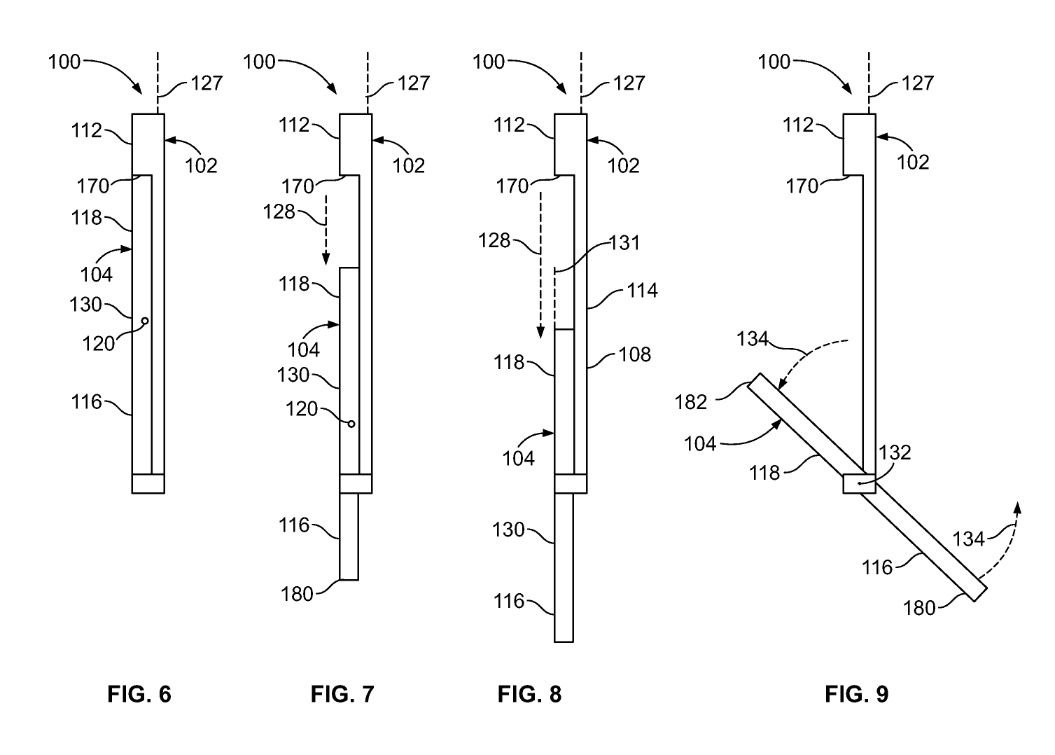

FIG. 6 illustrates a lateral view of the mobile computing device 100 having the input interface support stand 104 in a retracted position, according to an embodiment of the present disclosure. The input interface support stand 104 may be retained within a complementary recessed area 170 formed within a rear surface 112 of the main housing 102. In order to use the input interface support stand 104 in a supported operative orientation, such as an upright orientation, an individual engages the base 130, for example, of the input interface support stand 104 to slide it away from the recessed area 170.

FIG. 7 illustrates a lateral view of the input interface support stand 104 in a sliding position (that is, being slid towards an extended position) in relation to the main housing 102 of the mobile computing device 100, according to an embodiment of the present disclosure. As the individual grasps the base 130 and/or a proximal end 180 of the input interface support stand 104, the individual pulls the input interface support stand 104 in the direction of arrow 128 away from the recessed area 170 of the main housing 102.

FIG. 8 illustrates a lateral view of the input interface support stand 104 in a fully-extended slid position (that is, an extended position) in relation to the main housing 102 of the mobile computing device 100, according to an embodiment of the present disclosure. In the fully-extended slid position, ends of the pivot member 120 (hidden from view in FIG. 8) are pivotally retained by pivot terminals 142 (hidden from view in FIG. 8) of the opposed lateral brackets 114. In this position, the plane 131 of the base 130 is generally parallel to the plane 127 of the display screen 108.

FIG. 9 illustrates a lateral view of the input interface support stand 104 in a pivoting position in relation to the main housing 102 of the mobile computing device 100, according to an embodiment of the present disclosure. When portions, such as ends, of the pivot member 120 are pivotally retained with the pivot terminals 142 (as described and shown with respect to FIGS. 3 and 4), the individual may grasp the proximal end 180 and/or the distal end 182 of the input interface support stand 104 and pivot the input interface support stand 104 to a supporting position in the direction of arc 134, which is generally a radial direction centered about the pivot axis 132.

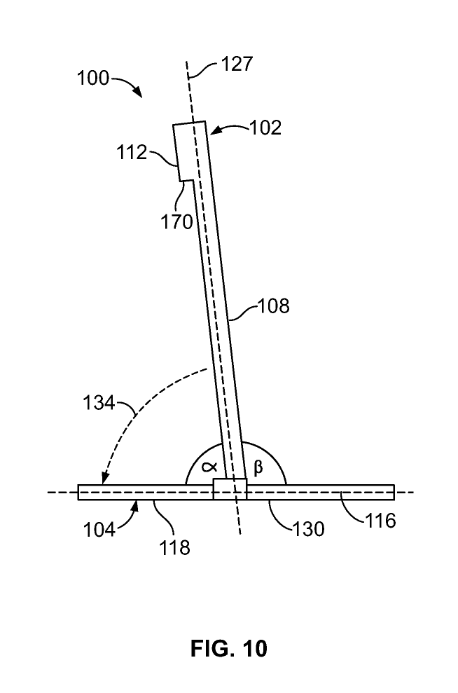

FIG. 10 illustrates a lateral view of the input interface support stand 104 supporting the main housing 102 of the mobile computing device 100 in a supporting position, such as an upright orientation, according to an embodiment of the present disclosure. As shown, the stabilizer 118 is to one side of the plane 127, while the input interface 116 is to an opposite side of the plane 127. An angle α is formed between the plane 127 and a top surface of the stabilizer 118, while an angle β is formed between the plane 127 and a top surface of the input interface 116. The sum of the angles α and β is 180°. The main housing 102 may be adjusted with respect to the input interface support stand 104 to various angles α and β.

In order to stow the input interface support stand 104 in the retracted position, the operation is reversed. For example, the input interface support stand 104 is pivoted into a position in which the base 130 is parallel with the display screen 108, such as shown in FIG. 8. The input interface support stand 104 is then slid back into the recessed area 170 in a direction opposite to that of arrow 128, such as shown in FIG. 6.

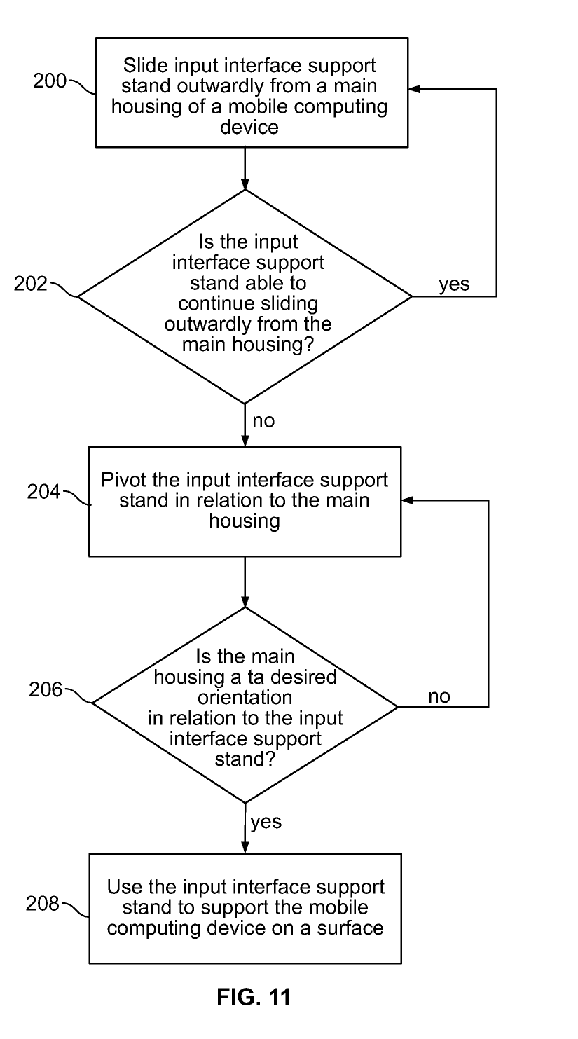

FIG. 11 illustrates a flow chart of a method of supporting a mobile computing device in a supporting position, such as an upright orientation, on a surface, according to an embodiment of the present disclosure. At 200, an input interface support stand is slid outwardly from a main housing of a mobile computing device. For example, the input interface support stand is slid out of a recessed area of the main housing in a direction that is parallel to a plane in which a display screen of the mobile computing device resides.

Next, at 202, it is determined whether the input interface support stand is able to continue to be slid outwardly from the main housing. If so, the process returns to the 200 in which the input interface support stand continues to be outwardly slid in relation to the main housing. If not, such as when at least a portion of a pivot member is pivotally retained within one or more pivot terminals of brackets of the main housing, the process continues to 204, in which the input interface support stand is pivoted in relation to the main housing. For example, the input interface support stand may be pivoted about a pivot axis of the pivot member, which is pivotally retained within the one or more pivot terminals.

At 206, it is determined whether the main housing is at a desired orientation in relation to the input interface support stand. If not, the process returns to 204 in which the input interface support stand continues to be pivotally adjusted in relation to the main housing. If so, the process continues to 208, in which the input interface support stand is placed on a surface of a structure, such as a table, to support the mobile computing device in an supported operative orientation, such as an upright orientation (in which the display screen is visible and a rear surface of the main housing does not contact the surface of the structure).

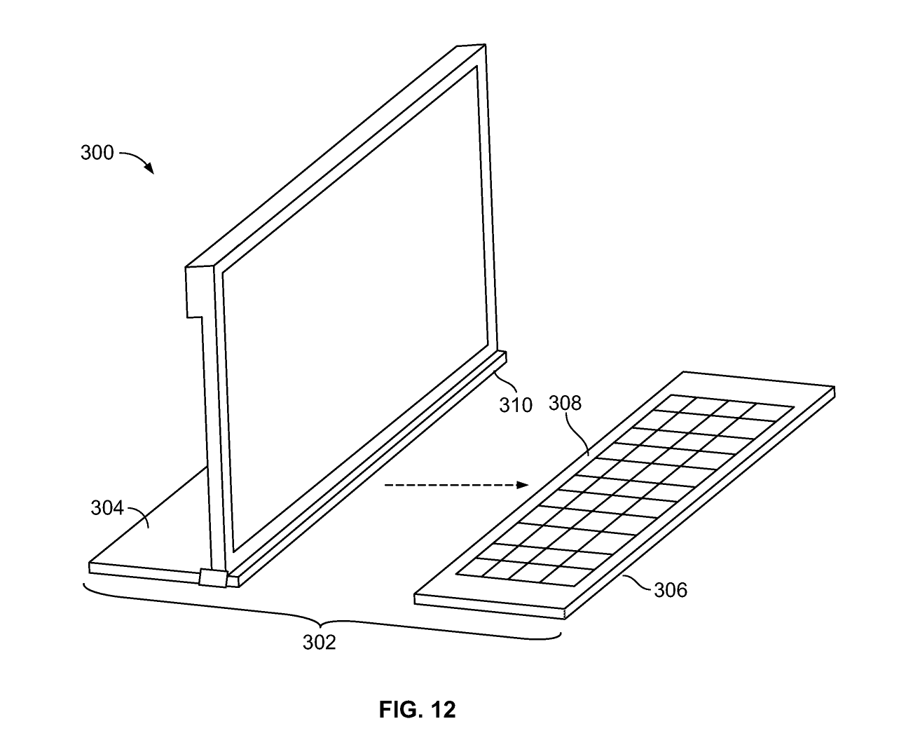

FIG. 12 illustrates a perspective front view of a mobile computing device 300 supported in an upright orientation by an input interface support stand 302, according to an embodiment of the present disclosure. As shown, the interface support stand 302 may include a stabilizer support 304 and an input interface 306. The input interface 306 may be detachable from the stabilizer support 304. For example, the input interface 306 may include a plug end 308 that is configured to be removably connected to a receptacle end 310 of the stabilizer support 304. In this manner, when the input interface support stand 302 is pivoted into a supporting position, as described above, the input interface 306 may be removed from the stabilizer support 310 so that an individual may use the input interface 306 at a remote location. The input interface 306 may be configured to wirelessly communicate (such as through Bluetooth, WiFi, or the like), for example, with a control unit of the mobile computing device 300. Any of the embodiments of the present application may include an input interface support stand having a separable input interface. Further, the input interface 306 may include a battery that provides power thereto. The battery may be charged by the mobile computing device 300 when the input interface 306 is connected to the stabilizer support 304.

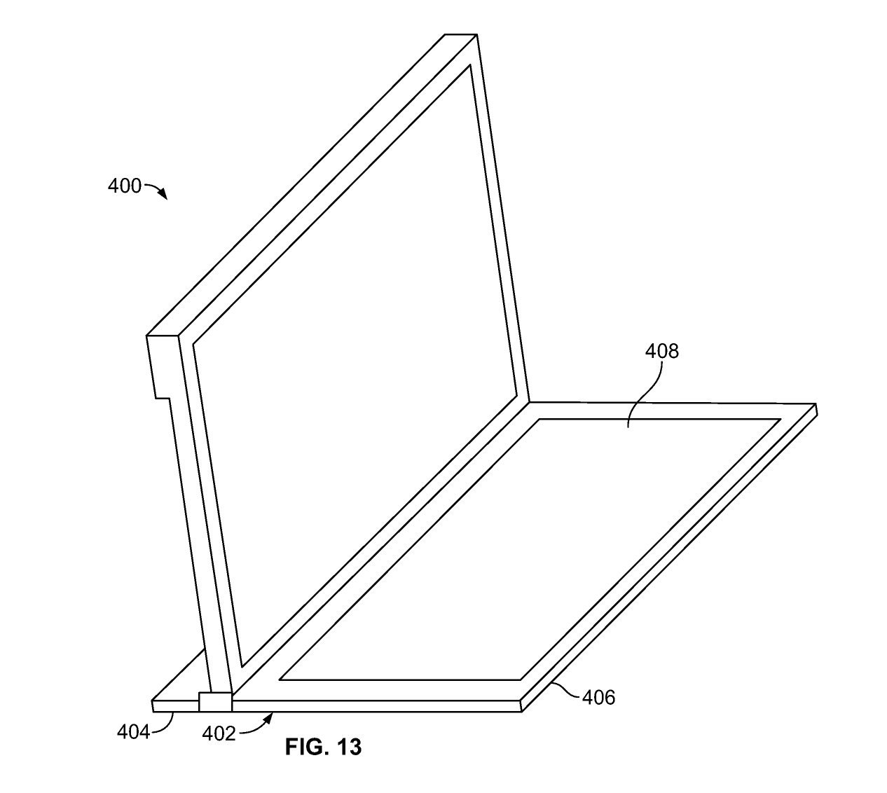

FIG. 13 illustrates a perspective front view of a mobile computing device 400 supported in an upright orientation by an input interface support stand 402, according to an embodiment of the present disclosure. The input interface support stand 402 may include a stabilizer support 404 connected to an input interface 406. The input interface 406 may be or include a touchscreen or pad 408 instead of, or in addition to, a keyboard, for example.

As shown, the pivot member (hidden from view) may not be at a middle portion of the input interface support stand 402. Instead, the pivot member may be shifted such that the stabilizer support 404 is shorter than the input interface 406, or vice versa.

Referring to FIGS. 1-13, embodiments of the present disclosure provide systems and methods for supporting a mobile computing device in an supported operative orientation, such as an upright orientation. The embodiments may include an input interface support stand that integrally connects an input interface to a stabilizer. The input interface support stand may be slid out from a portion of a main housing, and pivoted to a supporting position, in which an input interface is disposed in front of a central plane of a main housing, and a stabilizer support is disposed behind the central plane of the main housing.

FIG. 14 illustrates a simplified block diagram of a mobile computing device 500, according to an embodiment of the present disclosure. The mobile computing device 500 is an example of a mobile computing device that may include an input interface support stand, such as any of those described above. The mobile computing device 500 may include one or more wireless transceivers 502, one or more processors 504 (e.g., a microprocessor, microcomputer, application-specific integrated circuit, etc.), one or more local storage medium (also referred to as a memory portion) 506, a user interface 508 (such as a display screen that may include a touchscreen interface) which may include one or more input devices 509 and one or more output devices 510, a power module 512, and a component interface 514. All of these components can be operatively coupled to one another, and can be in communication with one another, by way of one or more internal communication links 516, such as an internal bus.

The input and output devices 509, 510 may each include a variety of visual, audio, and/or mechanical devices. For example, the input devices 509 can include a visual input device such as an optical sensor or camera, an audio input device such as a microphone, and a mechanical input device such as a keyboard, keypad, selection hard and/or soft buttons, switch, touchpad, touch screen, icons on a touch screen, a touch sensitive areas on a touch sensitive screen and/or any combination thereof. Similarly, the output devices 510 can include a visual output device such as a liquid crystal display screen, one or more light emitting diode indicators, an audio output device such as a speaker, alarm and/or buzzer, and a mechanical output device such as a vibrating mechanism. The display may be touch sensitive to various types of touch and gestures. As further examples, the output device(s) 510 may include a touch sensitive screen, a non-touch sensitive screen, a text-only display, a smart phone display, an audio output (e.g., a speaker or headphone jack), and/or any combination thereof.

The local storage medium 506 can encompass one or more memory devices of any of a variety of forms (e.g., read only memory, random access memory, static random access memory, dynamic random access memory, etc.) and can be used by the processor 504 to store and retrieve data. The data that is stored by the local storage medium 506 can include, but need not be limited to, operating systems, applications, user collected content and informational data. Each operating system includes executable code that controls basic functions of the communication device, such as interaction among the various components, communication with external devices via the wireless transceivers 502 and/or the component interface 514, and storage and retrieval of applications and data to and from the local storage medium 506. Each application includes executable code that utilizes an operating system to provide more specific functionality for the communication devices, such as file system service and handling of protected and unprotected data stored in the local storage medium 506.

Other applications stored in the local storage medium 506 may include various application program interfaces (APIs). The power module 512 may include a power supply, such as a battery, for providing power to the other components while enabling the mobile device 500 to be portable, as well as circuitry providing for the battery to be recharged. The component interface 514 provides a direct connection to other devices, auxiliary components, or accessories for additional or enhanced functionality, and in particular, can include a USB port for linking to a user device with a USB cable.

Each transceiver 502 can utilize a known wireless technology for communication. Exemplary operation of the wireless transceivers 502 in conjunction with other components of the mobile device 500 may take a variety of forms and may include, for example, operation in which, upon reception of wireless signals, the components of mobile device 500 detect communication signals and the transceiver 502 demodulates the communication signals to recover incoming information, such as voice and/or data, transmitted by the wireless signals. After receiving the incoming information from the transceiver 502, the processor 504 formats the incoming information for the one or more output devices 510. Likewise, for transmission of wireless signals, the processor 504 formats outgoing information, which may or may not be activated by the input devices 510, and conveys the outgoing information to one or more of the wireless transceivers 502 for modulation to communication signals. The wireless transceiver(s) 502 convey the modulated signals to a remote device, such as a cell tower or a remote server (not shown).

In accordance with at least one embodiment herein, to the extent that mobile computing devices are discussed herein, it should be understood that they can represent a very wide range of devices, applicable to a very wide range of settings. Thus, by way of illustrative and non-restrictive examples, such devices and/or settings can include mobile telephones, tablet computers, and other portable computers such as portable laptop computers.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. A system comprising:
a main housing including one or more processors and a display screen; and
an input interface support stand including an input interface integrally connected to a stabilizer, the input support stand movably secured to the main housing and movable between a retracted position in which the input interface support stand is securely retracted in relation to the main housing, and a supporting position in which the input interface support stand supports the main housing in a supported operative orientation.

2. The system of claim 1, wherein the input interface is positioned to a first side of a plane in which the display screen resides in the supporting position, and wherein the stabilizer is positioned to a second side of the plane in the supporting position, and wherein the first side is opposite from the second side.

3. The system of claim 1, wherein the input interface and the stabilizer have a common central plane.

4. The system of claim 1, wherein the input interface support stand is movable between the retracted position and an extended position in which the input interface outwardly extends from the main housing, and wherein a base of the input interface support is parallel to a plane in which the display screen resides in the extended position.

5. The system of claim 4, wherein the input interface support stand is pivotably moveable between the extended position and the supporting position.

6. The system of claim 1, wherein the stabilizer includes a flat panel.

7. The system of claim 1, wherein the input interface comprises one or both of a keyboard and a touchscreen.

8. The system of claim 1, wherein the user interface support stand comprises a pivot member, and wherein the main housing comprises one or more guide tracks having one or more pivot terminals, wherein one or more portions of the pivot member are retained within the one or more guide tracks.

9. The system of claim 1, wherein the user interface is removably connected to the stabilizer.

10. A system comprising:
a main housing including one or more processors and a display screen; and
a support stand integrally connected to a stabilizer, the support stand movably secured to the main housing and movable between a retracted position in which the support stand is securely retracted in relation to the main housing, and a supporting position in which the support stand supports the main housing in a supported operative orientation;
wherein the support stand is positioned to a first side of a plane in which the display screen resides in the supporting position, and wherein the stabilizer is positioned to a second side of the plane in the supporting position, and wherein the first side is opposite from the second side.

11. The system of claim 10 wherein the support stand further comprises an input interface.

12. The system of claim 11 wherein the input interface comprises an interface selected from the group consisting of a keyboard and a touchscreen.

13. The system of claim 10, wherein the support stand is movable between the retracted position and an extended position in which the support stand outwardly extends from the main housing, and wherein a base of the support stand is parallel to a plane in which the display screen resides in the extended position.

14. The system of claim 13, wherein the support stand is pivotably movable between the extended position and the supporting position.

15. The system of claim 10, wherein the support stand comprises a pivot member, and wherein the main housing comprises one or more guide tracks having one or more pivot terminals, wherein one or more portions of the pivot member are retained within the one or more guide tracks.

16. A system comprising:
a main housing including one or more processors, a local storage medium, and a display screen; and
an input interface support stand including an input interface integrally connected to a stabilizer having a common central plane with the input interface, wherein the input support stand is movably secured to the main housing and movable between a retracted position in which the input interface support stand is securely retracted in relation to the main housing, and a supporting position in which the input interface support stand supports the main housing in a supported operative orientation, wherein the input interface is positioned to a first side of a plane in which the display screen resides in the supporting position, wherein the stabilizer is positioned to a second side of the plane in the supporting position, wherein the input interface support stand is movable between the retracted position and an extended position in which the input interface outwardly extends from the main housing, wherein a base of the input interface support is parallel to a plane in which the display screen resides in the extended position, and wherein the input interface support stand is pivoted between the extended position and the supporting position.

17. The system of claim 16, wherein the stabilizer includes a flat panel.

18. The system of claim 16, wherein the input interface comprises one or both of a keyboard and a touchscreen.

19. The system of claim 16, wherein the user interface support stand comprises a pivot member, wherein the main housing comprises one or more guide tracks having one or more pivot terminals, and wherein one or more portions of the pivot member retained within the one or more guide tracks.

20. The system of claim 16, wherein the user interface is removably connected to the stabilizer.
